(19) United States
(12) Patent Application Publication
(10) Pub. No.: US 2010/0126073 A1
(43) Pub. Date: May 27, 2010

(54) ACTUATOR FOR ELEVATOR DOORS, ELEVATOR DOOR ARRANGEMENT INCLUDING SAME AND METHODS

(75) Inventors: Jonathan R. Schroeder, Machesney Park, IL (US); Joseph A. Binka, Belvidere, IL (US); Timothy J. LeCrone, Rockford, IL (US)

Correspondence Address: REINHART BOERNER VAN DEUREN P.C., 2215 PERRYGREEN WAY, ROCKFORD, IL, 61107, US

(73) Assignee: PACIFIC BEARING COMPANY, Rockford, IL (US)

(21) Appl. No.: 12/625,171

(22) Filed: Nov. 24, 2009

Related U.S. Application Data
(60) Provisional application No. 61/117,878, filed on Nov. 25, 2008.

(51) Int. Cl. E05F 17/00; E05F 15/14; E06B 3/38

(52) U.S. Cl. 49/118; 49/360; 49/506

(57) ABSTRACT

A double door actuation system is provided. The actuation system includes a base frame, a drive motor, first and second guide rails and a pair of rail support arrangements. The drive motor is mounted to the base frame and includes a pinion gear rotatable about an axis of rotation. The guide rails include opposed raceways and a gear rack. The gear rack engages the pinion gear opposite sides such that the pinion gear simultaneously drives the guide rails in opposite directions parallel to a drive axis. The rail support arrangements are mounted to the base frame and support guide rails. The rail support arrangements maintain a substantially constant lateral location of the guide rails in a direction perpendicular to both the drive axis and axis of rotation to maintain a substantially constant mesh between the pinion the gear racks.

### CROSS-REFERENCE TO RELATED PATENT APPLICATIONS

This patent application claims the benefit of U.S. Provisional Patent Application No. 61/117,878, filed Nov. 25, 2008, the disclosure and teachings of which are incorporated herein, in their entireties, by reference thereto.

### FIELD OF THE INVENTION

This invention generally relates to mechanisms for actuating doors and more particularly elevator doors.

### BACKGROUND OF THE INVENTION

Elevator doors typically have two doors that move relative to one another to open and close an elevator compartment. Unfortunately, prior elevator doors have complicated linkages to open and close the doors. This complicated linkage arrangement results in the door arrangement being a primary source for maintenance calls for elevators.

Further, it is desirable to have the doors operate smoothly because many people have a fear of elevators and that they may fail. However, when the doors on an elevator do not close smoothly, even though they do not generally affect the actual motion of the elevator, many elevator riders become apprehensive of the mechanical safety of the elevator as a whole.

The present invention relates to improvements over the current state of the art.

### BRIEF SUMMARY OF THE INVENTION

Embodiments of the present invention relate to a new and improved actuator for a double door elevator door. More particularly, the present invention relates to a high-precision, simplified actuator for a double door elevator door. However, embodiments of the invention may be applied to other double door arrangements and a door may merely be a shield such as in a manufacturing operation.

In a first implementation of the invention, a double door actuation system is provided. The actuation system includes a base frame, a drive motor, first and second guide rails and first and second rail support arrangements. The drive motor is mounted to the base frame and includes a pinion gear rotatable about an axis of rotation. The first guide rail includes opposed first and second raceways and a first gear rack. The first gear rack engages the pinion gear on a first side of the axis of rotation. The second guide rail includes opposed third and fourth raceways and a second gear rack. The second gear rack engages the pinion gear on a second side of the axis of rotation, opposite the first side. In this arrangement, rotation of the pinion gear simultaneously drives the first and second guide rails in opposite directions parallel to a drive axis. The first and second rail support arrangements are mounted to the base frame and support the first and second guide rails, respectively. The rail support arrangements maintain a substantially constant lateral location of the guide rails in a direction perpendicular to both the drive axis and axis of rotation to maintain a substantially constant mesh between the pinion gear and first and second gear racks.

In one embodiment, the first rail support arrangement is a first group of guide rollers engaging the first and second raceways and the second rail support arrangement is a second group of guide rollers engaging the third and fourth raceways. In a more preferred arrangement, each of the first and second groups of guide rollers includes at least three guide rollers, a first guide roller of the first rail support arrangement engaging the first raceway and second and third ones of the first rail support arrangement engaging the second raceway, a first guide roller of the second rail support arrangement engaging the third raceway and second and third ones of the second rail support arrangement engaging the fourth raceway.

In another arrangement, each of the first and second groups of guide rollers includes a fourth guide roller, the fourth guide roller of the first rail support arrangement engaging the first raceway and the fourth guide roller of the first rail support arrangement engaging the third raceway.

To provide precision actuation of attached doors and to prevent wear, friction, and backlash between the pinion and the first and second gear racks, in one embodiment, the first and second raceways have a parallelism per foot of less than or equal to 0.005 inches relative to a pitch diameter of the first gear rack and the third and fourth raceways have a parallelism per foot of less than or equal to 0.005 inches relative to a pitch diameter of the second gear rack. Even more preferably, the first and second raceways have a parallelism per foot of less than or equal to 0.001 inches relative to a pitch diameter of the first gear rack and the third and fourth raceways have a parallelism per foot of less than or equal to 0.001 inches relative to a pitch diameter of the second gear rack. In view of this parallelism, it is desired to have a parallelism per foot between the pitch diameters of the two gear racks 152 of less than or equal to 0.005 inches and even more preferably of less than or equal to 0.002 inches. Alternatively, the parallelism between the two pitch diameters of the opposed gear racks 152 could be measured as a variation between the two locations measured in a plane including the axis of rotation of the pinion gear 128 that extends perpendicularly to the drive axis 126. This parallelism could be quantified as an instantaneous variation between any two portions of the gear racks 152 that align with this plane including the rotational axis of the pinion gear 128 as they are driven back and forth by drive motor 104.

The parallelism measurements can be taken from a hypothetical reference point defined by the raceways or actual points of the raceways themselves.

To provide for cheaper construction, the first and second guide rails include first and second base rails with the first and second rear racks being mounted to the first and second base rails. Further yet, the guide rails may include first, second hardened rails mounted to the first base rail and providing the first and second raceways, respectively and third and fourth hardened rails mounted to the second base rail and providing the third and fourth raceways.

The raceways preferably provide lateral support to a cooperating structure such as a guide roller such that the guide roller does not move laterally relative to the corresponding raceway. This is typically done by providing a convex or concave profile to the raceways. In some embodiments, the raceways may have a convex or concave V-shape. Alternatively, the raceway profiles can have a gothic arch or merely be provided by an arcuate groove or a convex curve.

In one embodiment, the first and second raceways face away from one another and pass through the first rail support arrangement and the third and fourth raceways face away from one another and pass through the second rail support arrangement.

In an alternative embodiment, the first and second raceways face one another and the first rail support arrangement passes between the first and second raceways and the third and fourth raceways face one another and the second rail support arrangement passes between the third and fourth raceways.

To facilitate easy adaptation to various size pinion gears for operations that require more or less torque, the frame member in some embodiments includes a horizontal top plate to which the motor is attached and first and second sidewalls extending from the top plate in parallel spaced relation, the first and second rail support arrangements being mounted to the first and second sidewalls, respectively, the pinion gear being equally laterally interposed between the first and second sidewalls. In such an arrangement, the parallel spacing between the first and second sidewalls is adjustable relative to one another to accommodate varying sized pinions. Further yet, the first and second sidewalls may be adjustably connected to the top plate.

In another aspect, the invention provides a door assembly including an actuator including one or more of the features above in combination with a plurality of doors operably coupled to the guide rails.

In yet another aspect, the invention provides a method of controlling a pair of doors comprising; 1) simultaneously engaging a first guide rail connected to a first door and engaging a second guide rail connected to a second door with a pinion gear; 2) simultaneously driving the doors in opposite directions and away from one another; 3) the first guide rail including opposed first and second raceways and a first gear rack, the first gear rack engaging the pinion gear on a first side of an axis of rotation of the pinion gear; 4) the second guide rail including opposed third and fourth raceways and a second gear rack, the second gear rack engaging the pinion gear on a second side of the axis of rotation, opposite the first side, such that rotation of the pinion gear simultaneously drives the first and second guide rails in opposite directions parallel to a drive axis; and 5) maintaining a substantially constant mesh between the pinion and first and second gear racks.

Other aspects, objectives and advantages of the invention will become more apparent from the following detailed description when taken in conjunction with the accompanying drawings.

### BRIEF DESCRIPTION OF THE DRAWINGS

The accompanying drawings incorporated in and forming a part of the specification illustrate several aspects of the present invention and, together with the description, serve to explain the principles of the invention. In the drawings:

FIG. 1 is a perspective illustration of a double door actuation arrangement according to the teachings of the present invention;

FIG. 2 is a perspective partial illustration of the double door actuation arrangement of FIG. 1;

FIG. 3 is a bottom partial illustration of the double door actuation arrangement of FIG. 1;

FIG. 4 is a perspective illustration of the double door actuation arrangement of FIG. 1 and a double door that may be actuated by the double door actuation arrangement;

FIG. 5 is a perspective partial illustration of a rail support arrangement supporting a guide rail of the double door actuation arrangement of FIG. 1;

FIG. 6 is a perspective partial illustration of the rail support arrangement of FIG. 5;

FIG. 7 is an end view illustration of a guide rail of the double door actuation arrangement of FIG. 1;

FIG. 8 is an end view of an alternative embodiment of a guide rail that can be used in a double door actuation arrangement according to an embodiment of the present invention; and

FIG. 9 is a partial end view illustration of the double door actuation arrangement of FIG. 8.

While the invention will be described in connection with certain embodiments, there is no intent to limit it to those embodiments. On the contrary, the intent is to cover all alternatives, modifications and equivalents as included within the spirit and scope of the invention as defined by the appended claims.

### DETAILED DESCRIPTION OF THE INVENTION

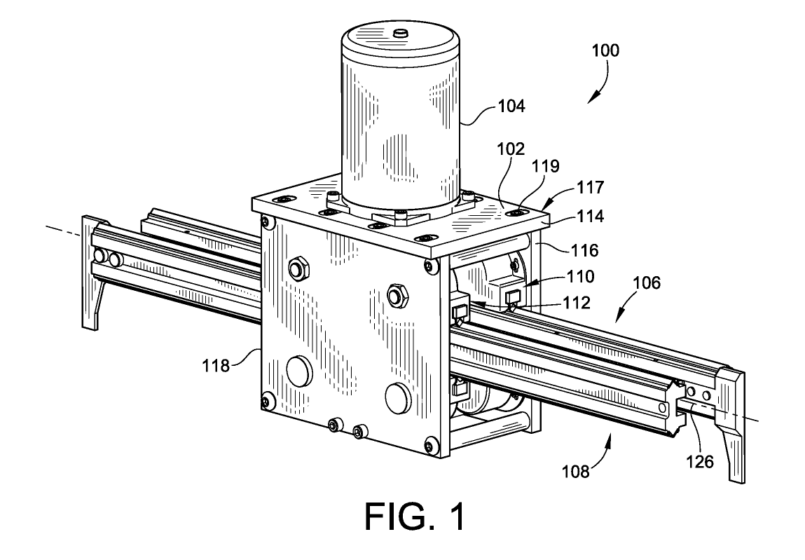

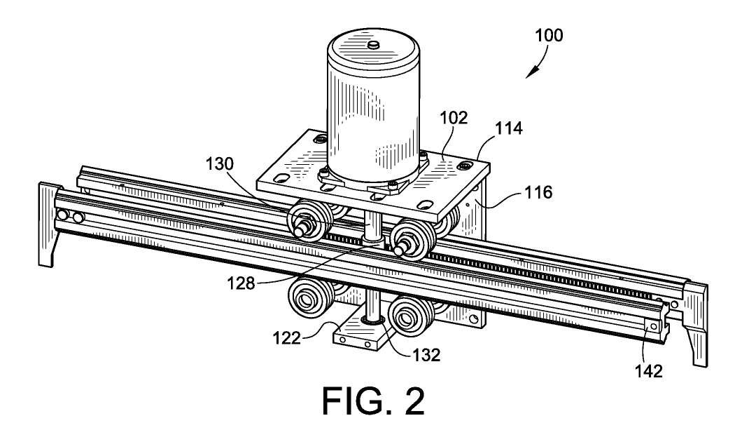

FIGS. 1 and 2 illustrate an embodiment of a double door actuation arrangement 100 according to the teachings of the present invention. The double door actuation arrangement 100 acts to drive two doors in opposite parallel directions using a single rotational input. In a preferred embodiment, the double door actuation arrangement 100 utilizes a double rack and pinion drive mechanism to drive the doors in opposite directions.

The double door actuation arrangement 100 generally includes a base frame 102, a drive motor 104, first and second guide rails 106, 108 and first and second rail support arrangements 110, 112.

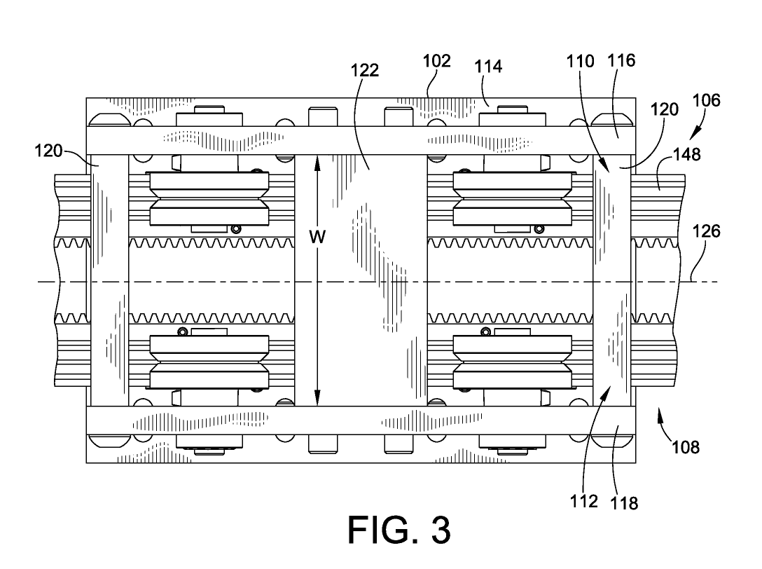

The base frame 102 generally includes a top plate 114 and two downward depending and parallel spaced apart sidewalls 116, 118. The sidewalls 116, 118 are preferably adjustably secured to the top plate 114 to permit adjusting the width W of the spacing therebetween (see FIG. 3) to accommodate different rack and pinion arrangements. As illustrated in FIG. 1, the top plate 114 includes a plurality of elongated slots 117 that receive cap screws 119 that permit laterally adjusting the spacing of sidewalls 116, 118 (e.g. width w).

The base frame 102 may also include a plurality of standoffs 120 extending laterally between and to maintain structural integrity and the parallel relationship between the sidewalls 116, 118. The base frame 102 also includes a bearing support plate 122 interposed between the sidewalls 116, 118 (see FIGS. 2 and 3).

Returning to FIG. 1, the motor 104 is affixed to the base frame 102 and more particularly to top plate 114, which may also be referred to as a motor mounting plate. The motor 104 is operably coupled to guide rails 106, 108 such that operation of the motor 104 drives guide rails 106, 108 in opposite directions along drive axis 126.

With reference to FIG. 2, the drive motor 104 is operably coupled to pinion gear 128 by a shaft extension 130. The shaft extension 130 is supported on an end opposite drive motor 104 by a bearing 132 mounted to bearing support plate 122. This arrangement prevents flexure in the shaft extension 130 to maintain a constant mesh between the pinion gear 128 and the guide rails 106, 108.

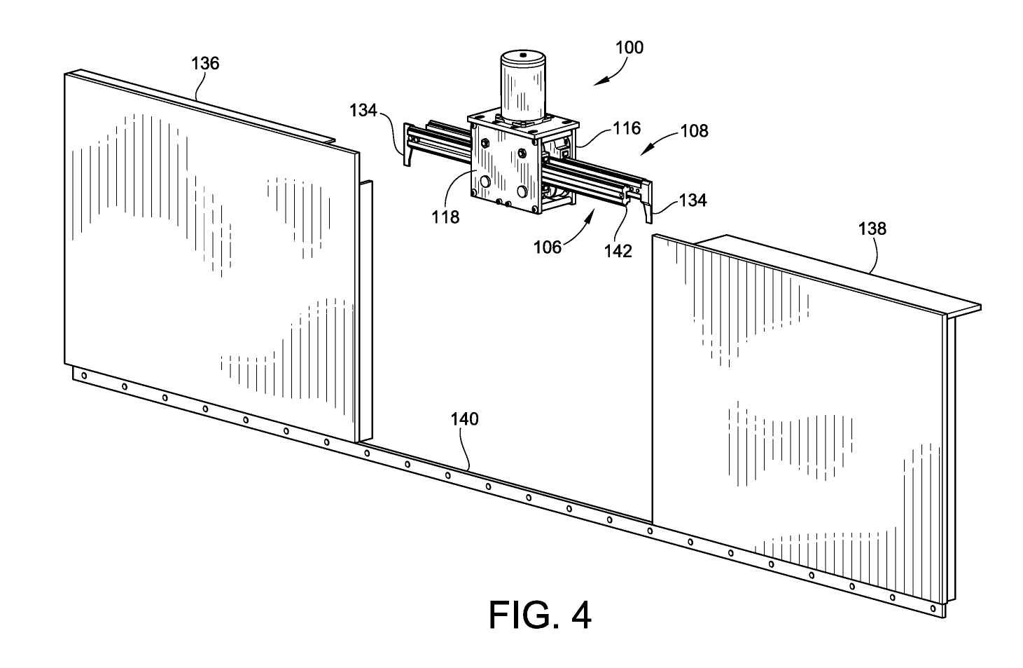

With reference to FIG. 4, each of the guide rails 106, 108 include door dogs 134 that fit into and or otherwise engage doors 136, 138 to transfer loading between the guide rails 106, 108 and doors 136, 138. Doors 136, 138 are vertically supported and laterally guided by door track 140. However, other arrangements for guiding the doors 136, 138 can be provided. Each guide rail 106, 108 preferably include positive hard stops 142 at ends opposite the ends that include dogs 134. The positive hard stops prevent the guide rails 106, 108 from being over extended. Typically, positive hard stops 142 will interfere with or abut an edge or side of the sidewalls 116, 118.

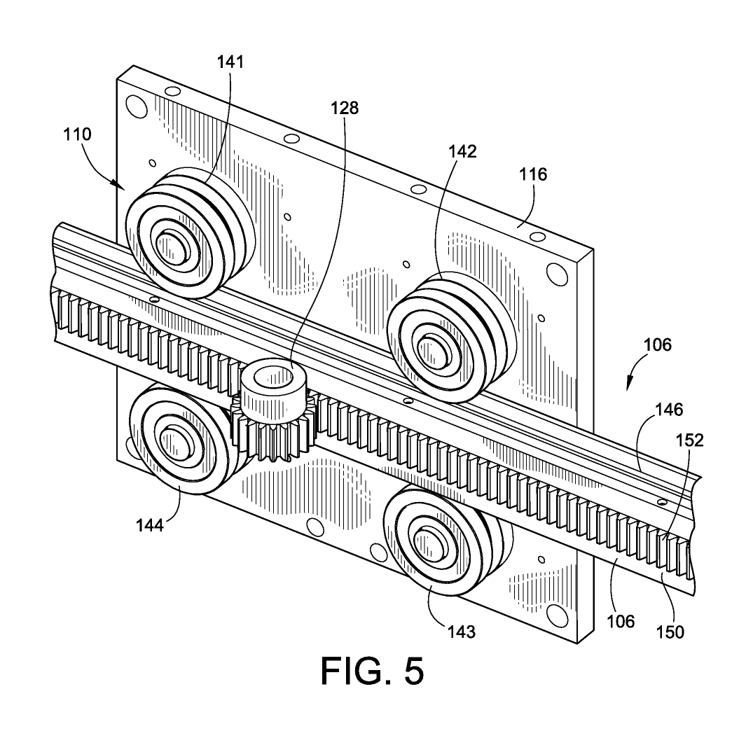

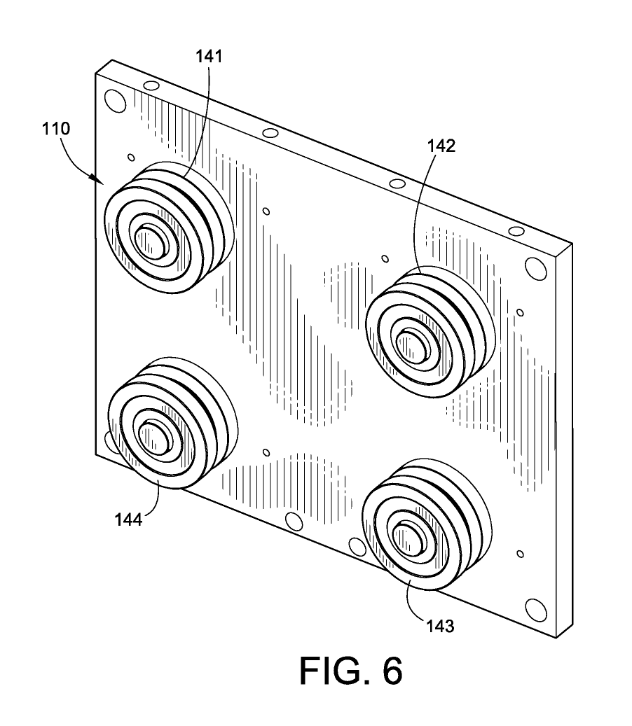

FIGS. 5 and 6 illustrate the support arrangement for the guide rails. For simplification, only a single one of the support arrangements will be described, but both guide rails 106, 108 are typically, but not necessarily, identically supported.

The first rail support arrangement 110 is generally provided by a plurality of guide rollers 141-144. The plurality of guide rollers 141-144 are mounted to sidewall 116 to maintain their spatial relationship. As illustrated in FIG. 5, the guide rail 106 passes through the first rail support arrangement 110. More particularly, guide rollers 141, 142 ride on an upper raceway 146 while guide rollers 143, 144 are spaced apart from guide rollers 141, 142 and ride on lower raceway 148 (not shown in FIGS. 5 and 6 but shown in FIG. 3).

While the first rail support arrangement 110 of the illustrated embodiment includes four (4) guide rollers 141-144, other arrangements can be used. However, at least three guide rollers are desired to prevent the guide rail from pivoting relative to the guide rollers. When using three guide rollers rather than four, two guide rollers would engage one raceway while a single guide roller would engage the other raceway. However, in this arrangement, the single guide roller is preferably axially interposed between the other two guide rollers to prevent pivoting of the guide rail.

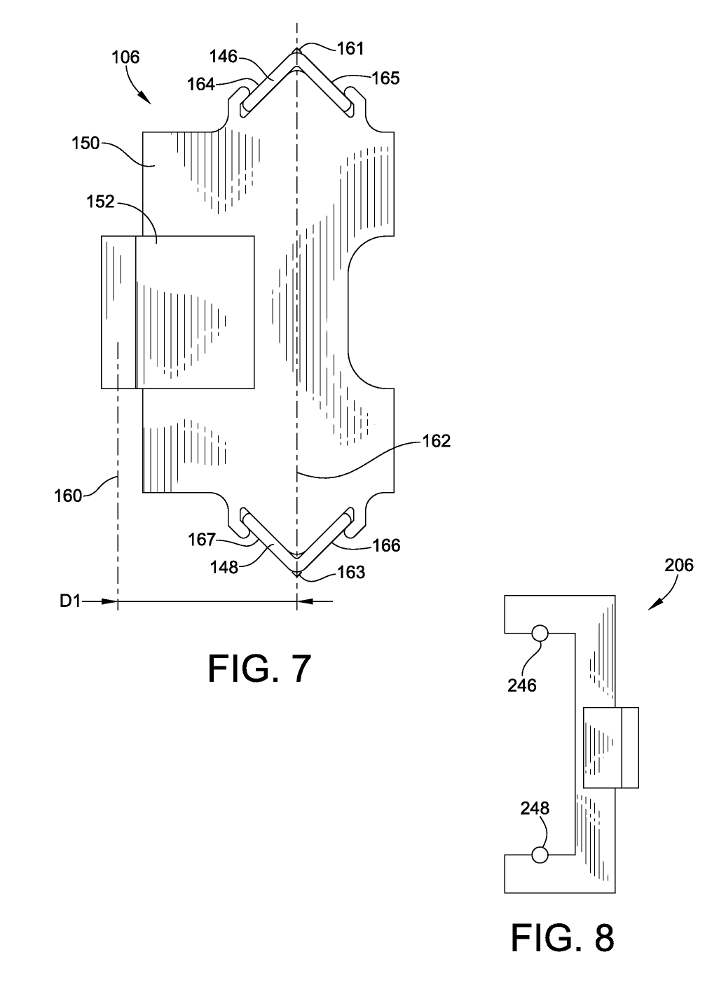

Further, while the illustrated embodiment has the guide rail 106 pass through the first rail support arrangement 110 and particularly between guide rollers 141-144 as illustrated in FIG. 5, other arrangements are contemplated. More particularly, rather than having the raceways 146, 148 face away from one another, as illustrated in FIG. 7, the raceways 246, 248 could face one another, such as illustrated in the embodiment of FIG. 8. In this embodiment, the rail support arrangements would actually pass between the raceways 246, 248 of the guide rail 206.

Further, while illustrated raceways are rounded or V-shaped, alternative raceways may be provided that include concave profiles and that could provide gothic arches or other raceway profiles. Further, while the raceways are illustrated as being provided by hardened rails mounted to a base rail, such as base rail 150 (see FIG. 7), other embodiments could have the raceways formed directly into the base rail material.

As illustrated in FIGS. 5 and 7, the guide rails 106 include a gear rack 152 mounted to the base rail 150. The pinion gear 128 meshes with the gear racks 152 to transfer rotational motion of drive motor 104 into linear motion of the guide rails 106, 108 parallel to drive axis 126 (see FIG. 3).

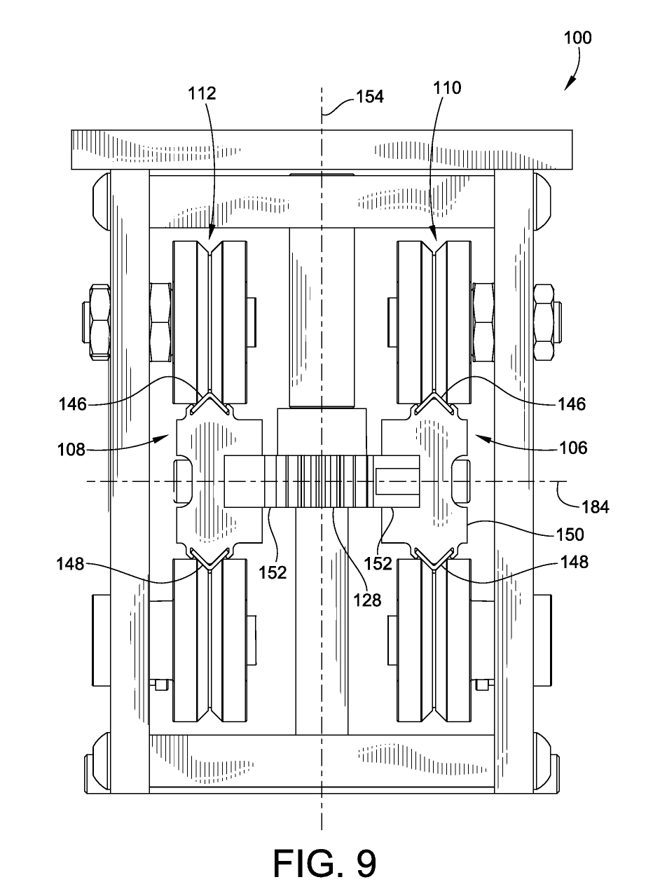

As illustrated in FIG. 9, guide rails 106, 108 are on opposite sides of pinion 128 such that as pinion 128 rotates angularly about axis of rotation 154, the two guide rails 106, 108 move parallel to one another in opposite directions.

The guide rails preferably have a precise parallelism between the raceways 146, 148 and the gear rack 152 to maintain a substantially constant mesh between the pinion gear 128 and the gear racks 152. Preferable guide rails and methods of forming such guide rails are provided in “GUIDE RAIL HAVING BASE RAIL AND GEAR RACK, METHOD OF MAKING SAME, GUIDE ASSEMBLY INCLUDING SAME” having U.S. Patent Application No. 61/117,795 which is incorporated herein in its entirety by reference thereto.

More particularly, and with reference to FIG. 7, the parallelism between the raceways 146, 148 and the pitch diameter 160 of the gear racks 152 is less than or equal to 0.005 inches per foot along the length of the guide rail 106 and more preferably less than or equal to 0.002 inches per foot length and even more preferably less than or equal to 0.001 inches per foot length. This parallelism can be measured as the variation in distance D1 defined between a plane 162 defined by two reference points defined by the raceways 146, 148 and the pitch diameter 160 of the gear rack 152. In the illustrated embodiment, the reference points defined by the raceways 146, 148 are provided by a theoretical intersection points 161, 163 of surfaces 164, 165 and 166,167 of raceways 146, 148, respectively. Plane 162 represents a theoretical lateral position of the guide rollers as they travel along raceways 146, 148.

However, the parallelism could be measured from other locations as well to establish that the raceways 146, 148 provide the desired parallelism relative to the gear rack. This parallelism requirement maintains a desired mesh between the pinion gear 128 and gear racks 152.

More particularly, with reference to FIG. 9, precise parallelism between raceways 146, 148 and gear racks 152 is desirable because of the fixed relationship of the guide rail support arrangements 110, 112 and pinion gear 128 during operation. Because the pinion gear 128 has a fixed position relative to the guide rail support arrangements 110, 112, and particularly the guide rollers thereof, any variation in the relative position of raceways 146, 148 relative to gear rack 152 directly affects the mesh with pinion gear 128, and particularly the gap, therebetween. Variations in this gap will cause premature wear of the pinion gear 128 and gear racks 152 as well as excessive backlash and noise.

The lateral position of the gear rack 152 relative to the pinion gear 128 is provided by the interaction of the guide rollers 141-144 with raceways 146, 148.

By having high parallelism within the guide rails 106, 108, the rail supports can maintain a substantially constant lateral location of the guide rails 106, 108, and particularly gear racks 152 along an axis 184 that is perpendicular to both the drive axis 126 and the axis of rotation 154 of the pinion gear 128.

In a further embodiment, the gear rack 152 may be integrally formed into the base rail 150 by standard machining techniques by way of example only by hobbing. However, the desired parallelism can be maintained by using a reference point relating to the raceways can be used to locate the machining/hobbing process.

All references, including publications, patent applications, and patents cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A double door actuation system, comprising:
a base frame;
a drive motor mounted to the base frame, the motor including a pinion gear rotatable about an axis of rotation;
a first guide rail including opposed first and second raceways and a first gear rack, the first gear rack engaging the pinion gear on a first side of the axis of rotation;
a second guide rail including opposed third and fourth raceways and a second gear rack, the second gear rack engaging the pinion gear on a second side of the axis of rotation, opposite the first side, such that rotation of the pinion gear simultaneously drives the first and second guide rails in opposite directions parallel to a drive axis; and
first and second rail support arrangements mounted to the base frame and supporting the first and second guide rails, respectively, the rail support arrangements maintaining a substantially constant lateral location of the guide rails in a direction perpendicular to both the drive axis and axis of rotation to maintain a substantially constant mesh between the pinion gear and first and second gear racks.

2. The double door actuation system of claim 1, further comprising first and second doors operably coupled to the first and second guide rails.

3. The double door actuation system of claim 1, wherein the first rail support arrangement is a first group of guide rollers engaging the first and second raceways and the second rail support arrangement is a second group of guide rollers engaging the third and fourth raceways.

4. The double door actuation system of claim 3, wherein each of the first and second groups of guide rollers includes at least three guide rollers, a first guide roller of the first rail support arrangement engaging the first raceway and second and third ones of the first rail support arrangement engaging the second raceway, a first guide roller of the second rail support arrangement engaging the third raceway and second and third ones of the second rail support arrangement engaging the fourth raceway.

5. The double door actuation system of claim 4, wherein each of the first and second groups of guide rollers includes a fourth guide roller, the fourth guide roller of the first rail support arrangement engaging the first raceway and the fourth guide roller of the second rail support arrangement engaging the third raceway.

6. The double door actuation system of claim 1, wherein the first and second raceways have a parallelism per foot of less than or equal to 0.005 inches relative to a pitch diameter of the first gear rack and the third and fourth raceways have a parallelism per foot of less than or equal to 0.005 inches relative to a pitch diameter of the second gear rack.

7. The double door actuation system of claim 6, wherein the first and second raceways have a parallelism per foot of less than or equal to 0.001 inches relative to a pitch diameter of the first gear rack and the third and fourth raceways have a parallelism per foot of less than or equal to 0.001 inches relative to a pitch diameter of the second gear rack.

8. The double door actuation system of claim 1, wherein the first and second guide rails include first and second base rails, the first and second gear racks being mounted to the first and second base rails, respectively.

9. The double door actuation system of claim 8, further including first, second hardened rails mounted to the first base rail and providing the first and second raceways, respectively and further including third and fourth hardened rails mounted to the second base rail and providing the third and fourth raceways, respectively.

10. The double door actuation system of claim 9, wherein the first and second raceways face away from one another and pass through the first rail support arrangement and the third and fourth raceways face away from one another and pass through the second rail support arrangement.

11. The double door actuation system of claim 9, wherein the first and second raceways face one another and the first rail support arrangement passes between the first and second raceways and the third and fourth raceways face one another and the second rail support arrangement passes between the third and fourth raceways.

12. The double door actuation system of claim 9, wherein the hardened rails are V-shaped.

13. The double door actuation system of claim 9, wherein the hardened rails provide rounded raceways.

14. The double door actuation system of claim 1, wherein the frame member includes a horizontal top plate to which the motor is attached and first and second sidewalls extending from the top plate in parallel spaced relation, the first and second rail support arrangements being mounted to the first and second sidewalls, respectively, the pinion gear being laterally interposed between the first and second sidewalls.

15. The double door actuation system of claim 14, wherein the parallel spacing between the first and second sidewalls is adjustable relative to one another.

16. The double door actuation system of claim 15, wherein the first and second sidewalls are adjustably connected to the top plate.

17. An elevator door assembly comprising:
first and second doors;
an actuation mechanism operably coupled to each of the first and second doors to drive the doors towards each other and away from one another, the actuation mechanism including:
a base frame;
a drive motor mounted to the base frame, the motor including a pinion gear rotatable about an axis of rotation;
a first guide rail including opposed first and second raceways and a first gear rack, the first gear rack engaging the pinion gear on a first side of the axis of rotation;
a second guide rail including opposed third and fourth raceways and a second gear rack, the second gear rack engaging the pinion gear on a second side of the axis of rotation, opposite the first side, such that rotation of the pinion gear simultaneously drives the first and second guide rails in opposite directions parallel to a drive axis; and
first and second rail support arrangements mounted to the base frame and supporting the first and second guide rails, respectively, the rail supports maintaining a substantially constant lateral location of the guide rails in a direction perpendicular to both the drive axis and axis of rotation to maintain a substantially constant mesh between the pinion and first and second gear racks.

18. A method of controlling a pair of doors comprising:
simultaneously engaging a first guide rail connected to a first door and engaging a second guide rail connected to a second door with a pinion gear; and
simultaneously driving the doors in opposite directions and away from one another;
the first guide rail including opposed first and second raceways and a first gear rack, the first gear rack engaging the pinion gear on a first side of an axis of rotation of the pinion gear;
the second guide rail including opposed third and fourth raceways and a second gear rack, the second gear rack engaging the pinion gear on a second side of the axis of rotation, opposite the first side, such that rotation of the pinion gear simultaneously drives the first and second guide rails in opposite directions parallel to a drive axis; and
maintaining a substantially constant mesh between the pinion and first and second gear racks.

19. The method of claim 18, wherein the step of maintaining a substantially constant mesh between the pinion and first and second gear racks includes maintaining a parallelism between the first and second raceways and the first gear rack of less than or equal to 0.005 inches and maintaining a parallelism between the third and fourth raceways and the second gear rack of less than or equal to 0.005 inches.

20. The method of claim 18, wherein the step of maintaining a substantially constant mesh between the pinion and first and second gear racks includes maintaining a parallelism between the first and second raceways and the first gear rack of less than or equal to 0.001 inches and maintaining a parallelism between the third and fourth raceways and the second gear rack of less than or equal to 0.001 inches.
